(19) United States
(12) Patent Application Publication
(10) Pub. No.: US 2006/0025063 A1
(43) Pub. Date: Feb. 2, 2006

(54) Control valve for a ventilation system of an automobile

(75) Inventors: Reinhold Burr, Heidenheim (DE); Uwe Fritsche, Troy, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BEHR GmbH & Co., Stuttgart (DE)

(21) Appl. No.: 10/809,282

(22) Filed: Mar. 25, 2004

(51) Int. Cl. B60H 1/00

(52) U.S. Cl. 454/69

(57) ABSTRACT

This invention concerns a control valve for a ventilation system of an automobile, with at least one edge over which air flows, which can be moved from at least a first into at least a second position. The control valve as per the invention is mainly two-dimensional and has in particular a changing cross-sectional profile in the area of the overflowed edge. Due to this cross-sectional profile, at least one sub area of the overflowing air is diverted into a number of flow directions deviating from the main flow direction.

### FIELD OF THE INVENTION

This invention pertains to a control valve for a ventilation system of an automobile.

### BACKGROUND OF THE INVENTION

Such control valves for a ventilation system of an automobile are known from the state of the art. These control valves are used, for example, in air ducts to change the volume flow but also to direct the air flow in a predetermined direction when there are a number of flow paths. Furthermore, such control valves also serve to open or close predetermined flow paths, e.g. for air, whereby, as is common for ventilation systems in automobiles, the air flow is directed, for example, to the foot area of the passengers or to the inside of the windshield. Certain components of the ventilation system can also be turned on by selecting the flow path.

The valves known from the state of the art exhibit, among other things, noise problems, for example, frequent hissing or whistling. These noise problems occur in particular with small valve aperture angles of the control valve and are considered bothersome to automobile passengers.

The state of the art also uses different versions of flexible seals for control valves, which can lead to a noise problem depending on the application and the geometry of the housing.

The cause for these types of noise problems is, for example, high air speeds on the sealing surface, whereby, depending on the raised-face geometry, air flow speeds can occur locally, which can lead to whistling and/or frequent hissing due to the interaction between the air flow and the sealing edge of a valve. It is known that this problem can occur with soft plastic-extrusion-coated valves as well as with hard sealing edges of valves.

### BRIEF SUMMARY OF THE INVENTION

The goal of this invention is to avoid and/or reduce known problems and to provide an improved control valve for ventilation systems, in particular in automobiles. The goal is achieved through a control valve as per the invention for a ventilation system in an automobile in accordance with claim 1 and through a process for reducing flow noises in a ventilation system in accordance with claim 13. Preferred embodiments of the invention are subjects of the sub-claims.

### DETAILED DESCRIPTION OF THE INVENTION

The valve as per the invention for a ventilation system of an automobile has at least one edge over which air passes and that can be moved at least from a first position to a second position. The control valve as per the invention is characterized in that the mainly two-dimensional valve, in particular in the area of the edge by which air passes, has a changing cross-sectional profil, which diverts at least a subarea of the passing air into a number of flow directions deviating from the main flow direction of the air flow.

As per this invention, the main direction is characterized as the direction of the main air flow, in which a number of flow particles mainly follow a predetermined flow path. The main flow direction can have a laminar flow, in particular in a subarea, which can however have turbulent areas, in particular in the edge areas, i.e. in the barrier layers.

In terms of this invention, the term “two-dimensional valve” is to be understood to mean the main span direction of the valve that has two dimensions, whereby it is not excluded that the valve has a different cross-sectional strength. In particular, the valve can be designed such that it has a cross section that tapers from the rotation axis. This can be a continuous as well as a step-like change.

In terms of this invention, the ventilation system is understood to mean, in particular, flow ducts and the components located therein that, e.g., feed fresh air from outside into the interior of an automobile and/or purge exhaust air from the interior of an automobile to the outside. Such ventilation systems are, for example, ventilation systems with heat exchangers, air-conditioning systems, auxiliary heating systems, etc. for automobiles, as known from the state of the art.

A preferred embodiment of the control valve as per the invention has cross-sectional super-elevations in the overflowed edge area that can, for example, be cross-sectional variations that are distributed evenly or unevenly over the edge length.

In accordance with a further embodiment of the invention, such cross-sectional super-elevations can be produced in that the edges of the control valve are coated with a plastic and the thickness of the plastic layer is varied. Furthermore, the control valve can be provided with notches, which e.g. during coating with a plastic leads to the desired cross-sectional super-elevation or cross-sectional profile. Of course, it also makes sense to produce the cross-sectional super-elevations using other processes known from the state of the art. In particular, in terms of the invention, flow bodies (as described below) may be used and these may be covered with plastic.

In accordance with a particularly preferred embodiment of the invention, the control valve has flow bodies in the overflowed edge area. The flow bodies themselves are, as per another particularly preferred embodiment, so-called turbulence generators, which e.g. are selected from a group of structures, which include pinnacles, calottes, nubs, pyramids, indentations, gratings, grating sections, cylinders, combinations of these, etc.

It also makes sense in terms of the invention to arrange the flow bodies in a predetermined angle in relation to the control valve edge over which the air flows.

Thus, for example, such a flow body can have an angle between 90° and 25°, preferably 60° to 45°, in relation to the edge area of the control valve.

In accordance with another particularly preferred embodiment, the control valve is an integral injection-molding part that, in accordance with another particularly preferred embodiment, has reinforcing ligaments that ensure sufficient flexural rigidity of the control valve.

In accordance with another particularly preferred embodiment, several control valves are arranged next to each other on a predetermined rotation axis, whereby, in accordance with another particularly preferred embodiment, notches preferably extending at least from an outer edge with a predetermined length towards the rotation axis of the valves are provided between the individual control valves.

In accordance with a particularly preferred embodiment of the invention, the control valve has at least one rotation axis, the end area of which is at least provided with a coupling device. For one, it serves to provide a defined storage or a defined drive for the valve.

Thus, a drive can be connected directly or indirectly with the coupling device via a drive shaft in order to, for example, move the control valve in a number of positions.

Of course, it also makes sense in terms of the invention to store the control valve in the end areas of the rotation axis and to use an independently arranged controlling device, which directly controls the valve.

Furthermore, the control valve based on the invention has at least one sealing edge that, in accordance with another particularly preferred embodiment, is implemented as a soft or hard sealing edge. Together with, for example, an air duct, this type of sealing edge serves to provide a predetermined seal for the air flow in the closed position of the control valve.

In accordance with a particularly preferred embodiment of the invention, either the closing edge of the air duct or the sealing edge of the control valve has a soft area. The respective opposite edge then has a hard closure. It also makes sense in terms of the invention that, for example, the air duct containing a control valve as per the invention has at least one stopper, which, together with at least one edge or one edge area of the control valve as per the invention, causes a predetermined sealing of the air duct when in the closed position.

The invention also comprises air-flow routing devices with at least one fan, one air duct, one heat exchanger for an automobile, and at least one control valve as per the invention. The use of a control valve as per the invention in a ventilation system and/or air-condition system of an automobile is also part of this invention.

The goal of the invention is also achieved through a process for reducing the flow noises in a ventilation system that is characterized in that at least one sub-area of the air flowing by the control valve is diverted into a number of flow directions deviating from the main flow direction.

For this, the control valve as per the invention has, in particular, flow bodies that are arranged and designed according to the aforementioned embodiments.

The control valve as per the invention is described below using a preferred embodiment. Please note that the embodiment described here is only one possible version out of a number of embodiments for a control valve as per the invention. This can be seen in particular when taking into consideration the turbulence generators used, whereby the form and design of the control valve itself can also be adjusted to meet the requirements of the ventilation system.

### BRIEF DESCRIPTION OF THE DRAWINGS

FIG. 1 shows a lateral view of control valve as per the invention.

FIG. 2 shows a top view of the control valve as per the invention as per FIG. 1.

FIG. 3 shows a schematized perspective view of a control valve as per the invention.

FIG. 4 shows an opened sub area of a ventilation system with a control valve as per the invention.

FIG. 5 shows a perspective view of an opened ventilation system with a control valve as per the invention.

FIG. 6 shows a detailed view from FIG. 4 of a slightly opened control valve as per the invention.

FIG. 7 shows a detailed view from FIG. 4 of a closed control valve as per the invention.

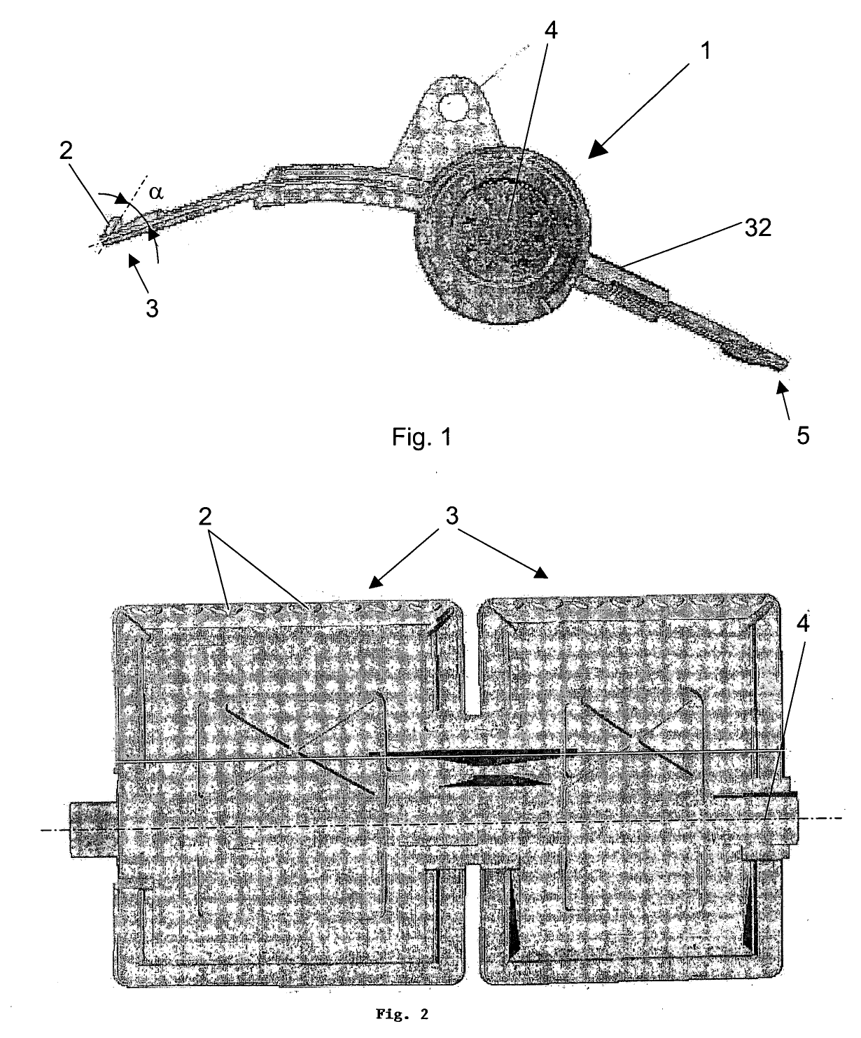

FIG. 1 is a lateral view of a control valve 1 as per the invention. On the left side is a first edge area 3 and on the right side is an edge area 5. The mainly two-dimensional valve has ridges in the middle area that are effected by the ligaments 32 and the turbulence generators 2 in the edge area. In accordance with the embodiment described here, the turbulence generators are arranged at a predetermined angle α, which lies at approx. 40°.

As per the embodiment described here, the turbulence generators are nubs or pinnacles that are arranged in the outer area of the overflowed edges of the control valve. Note that the turbulence generators, which are tapered on the side facing the air flow, and the routing of the air flow thereby separate the air stream via the nubs and the constrictions located in between into a number of smaller air streams that are diverted from the above-lying areas of the air flow.

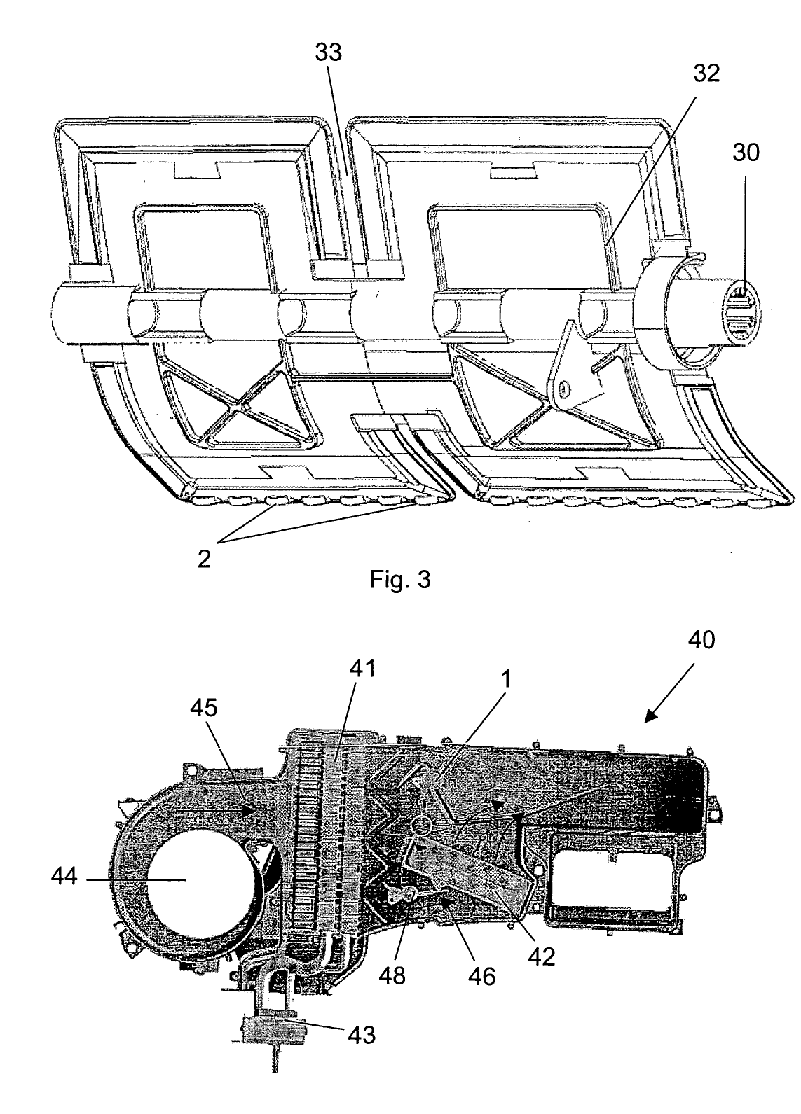

FIG. 3 shows the structure of a control valve as per the invention using a schematized perspective. In addition to the coupling area 30, the reinforcing ligaments 32 and the notches between the individual flaps 33 can be recognized. The turbulence generators 2 can also be seen on the bottom side of the valve.

FIG. 4 shows the arrangement of a control valve as per the invention in an open ventilation system. The ventilation system has a fan 44, a flow channel 45, and a heat exchanger 41. The heat exchanger is supplied with a coolant via the feed lines 43. The air flows through the heat exchanger and, as per the switch position of the flaps 1 and 48 shown here, is directed through a second downstream heat exchanger 42 and into a discharge section of the ventilation system 40. For this, the control valve is 48 open and the control valve 1 is closed. For the sake of completeness, it is noted that lateral walls, which are closed by an appropriately formed attachment, extend along the outer edges of the ventilation system i.e. of the flow channels.

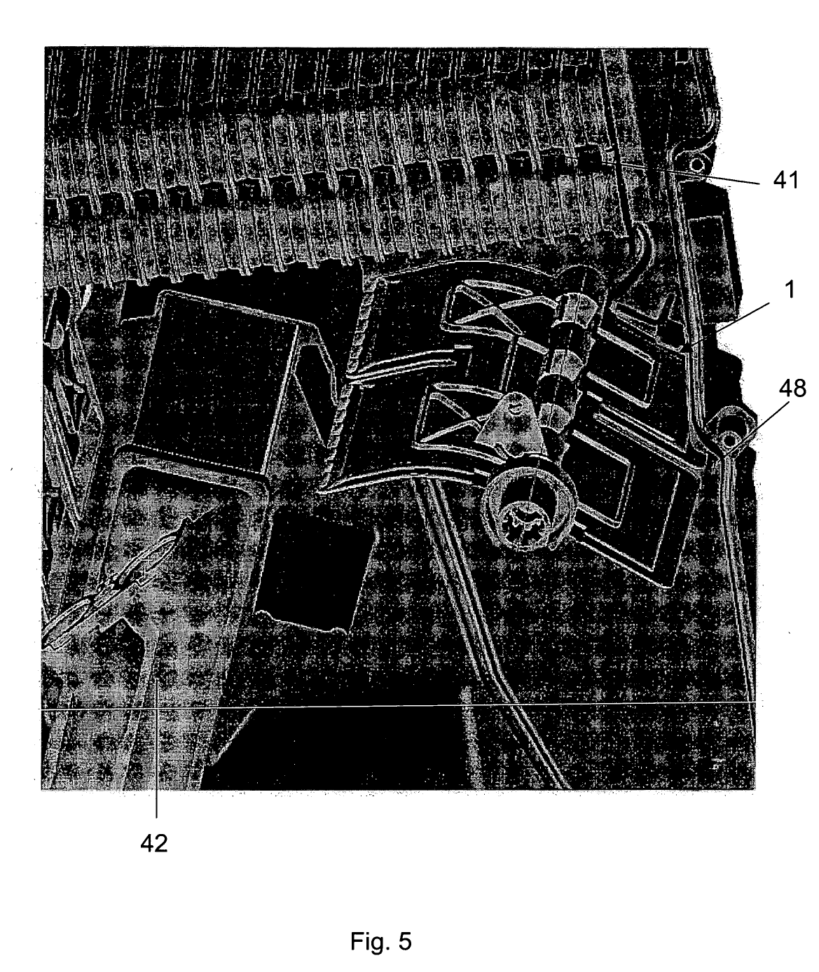

FIG. 5 shows a perspective view of a control valve as per the invention in a ventilation system in accordance with FIG. 4. The heat exchangers 41 and 42 can be seen, whereby the arrangement of the control valve as per the invention is designed so that, when closed, it lies against the wall of the flow channel 48. In particular, this provides support for the control valve when closed, in turn creating an improved seal.

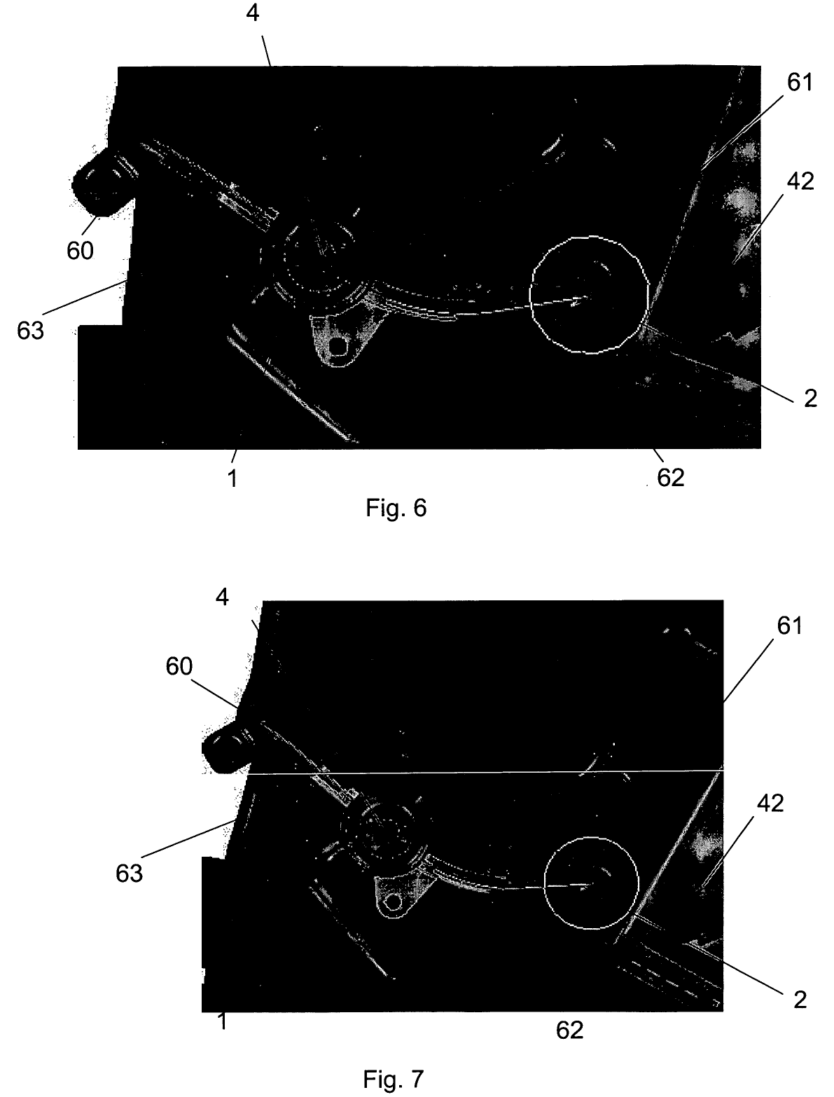

FIG. 6 shows the top view of the control valve in accordance with FIG. 4. The control valve can be opened easily, so that the air flow 62 is directed over the overflowed edge 3 into the subsequent section of the flow channel. Especially in this position, the control valve as per the invention causes the air stream 62 to be fragmented by the turbulence generators in the overflowed edge area of the control valve so that in particular larger flow structures are fragmented by the turbulence bodies and diverted from the main flow direction.

Furthermore, the turbulence generators cause the overflowed edge 3 of the control valve to be reinforced, which also has a positive effect for potential acoustical effects. Vibrations in particular can hereby be reduced in the end area of the control valve.

FIG. 7 shows a closed control valve as per the invention. The control valve is hereby adjacent to the projection of the lateral wall of the air duct on the right as well as on the left.

1. Device for ventilating a passenger cabin of an automobile, comprising at least one control valve with at least one edge overflowed with air in a main flow direction that can be moved from a first position to a second position, wherein the overflowed edge has a changing cross-sectional profile, which diverts at least a portion of the air flowing over the edge in the main flow direction into a plurality of stream directions deviating from the main flow direction.

2-16. (canceled)
